(19) United States
(12) Patent Application Publication
(10) Pub. No.: US 2008/0008978 A1
(43) Pub. Date: Jan. 10, 2008

(54) TREATMENT DEVICE AND METHOD FOR TREATING OR PREVENTING PERIODONTAL DISEASE THROUGH APPLICATION OF HEAT

(75) Inventors: Robert Conrad, Spring, TX (US); Charles Conrad, Spring, TX (US); Walter V. Klemp, Houston, TX (US)

Correspondence Address: FULBRIGHT & JAWORSKI L.L.P, 2200 ROSS AVENUE, SUITE 2800, DALLAS, TX, 75201-2784, US

(73) Assignee: Tyrell, Inc., Houston, TX (US)

(21) Appl. No.: 11/766,560

(22) Filed: Jun. 21, 2007

Related U.S. Application Data
(63) Continuation-in-part of application No. 11/429,927, filed on May 8, 2006.

(51) Int. Cl. A61C 3/00; A61C 5/14

(52) U.S. Cl. 433/32; 128/861

(57) ABSTRACT

A regulated heat source is described that can be applied to the teeth and gums in order to accelerate the death of the bacterial or viral systems known to contribute to periodontal disease. The regulated heat source can use a segmented mouthpiece to facilitate application of the thermal energy to the teeth and gums

### RELATED APPLICATIONS

This application is a continuation-in-part of U.S. patent application Ser. No. 11/429,927, filed May 8, 2006.

### TECHNICAL FIELD

The present invention relates to methods and devices for treatment or prevention of periodontal disease. More specifically, the present invention relates to methods and devices for treatment or prevention of periodontal disease involving the application of a dose of thermal energy to the teeth and gums.

### BACKGROUND OF THE INVENTION

Gum disease or periodontal disease, a chronic inflammation and infection of the gums and surrounding tissue, is the major cause of about 70 percent of adult tooth loss, affecting three out of four persons at some point in their life. Bacterial plaque—a sticky, colorless film that constantly forms on the teeth—is recognized as the primary cause of gum disease. Specific periodontal diseases may be associated with specific bacterial types. If plaque is not removed each day by brushing and flossing, it hardens into a rough, porous substance called calculus (also known as tartar). Toxins (poisons) produced and released by bacteria in plaque irritate the gums. These toxins cause the breakdown of the fibers that hold the gums tightly to the teeth, creating periodontal pockets which fill with even more toxins and bacteria. As the disease progresses, pockets extend deeper and the bacteria moves down until the bone that holds the tooth in place is destroyed. The tooth eventually will fall out or require extraction.

There are two major types of periodontal disease: gingivitis and periodontitis. Gingivitis is the stage of periodontal disease when the gums are inflamed and beginning to pull back from the teeth, but there is no damage yet to the connective tissue and bone. Ordinary gingivitis is the most common and least severe form of periodontal disease, and symptoms include red, swollen gums that bleed easily. People with gingivitis may have persistent bad breath. Treatment at this stage of the disease is very effective.

Gingivitis may lead to periodontitis, which is characterized not only by inflamed gums but also by deep pockets between gums and teeth; in advanced cases, there is destruction of the underlying connective tissue and bone. The most common type of periodontitis is adult periodontitis. It may start as early as the teen years, but symptoms usually do not become noticeable until the mid-30s or later. Symptoms slowly get worse as the person ages, but may come and go depending on a person's general health, oral hygiene and ability to combat the bacteria that cause the inflammation. Periodontitis is also more common in people with other diseases and disorders, including type 1 diabetes, AIDS and Down's syndrome.

In the healthy mouth, more than 350 species of microorganisms have been found. Periodontal infections are linked to fewer than 5% of these species. Among the bacteria most implicated in periodontal disease and bone loss are the following:

Actinobacillus (A.) actinomycetemcomitans and Porphyromonas (P.) gingivalis. These two bacteria appear to be particularly likely to cause aggressive periodontal disease. Both P. gingivalis and A. actinomycetemcomitans, along with multiple deep pockets in the gum, have been shown to be associated with resistance to standard treatments for gum disease. Particularly virulent strains of the P. gingivalis bacterium may be responsible for periodontal disease. Some evidence suggests that the P. gingivalis produces enzymes, such as arginine-specific cysteine proteinase, which may be the specific destructive factors that disrupt the immune system and lead to subsequent periodontal connective tissue destruction.

Bacteroides (B.) forsythus is also strongly linked to periodontal disease. Other bacteria associated with periodontal disease are T. denticola, T. sokranskii and P. intermedia. These bacteria, together with P. gingivalis, are frequently present at the same sites, and are associated with deep periodontal pockets.

Some bacteria are related to gingivitis, but not plaque development. They include various streptococcal species.

Certain herpes viruses (herpes simplex and varicella-zoster virus, the cause of chicken pox and shingles) are known causes of gingivitis, and other herpes viruses (cytomegalovirus and Epstein-Barr) may play a role in the onset or progression of some types of periodontal disease, including aggressive and severe chronic periodontal disease. It has been hypothesized that these viruses may cause periodontal disease in different ways, including release of tissue-destructive cytokines, overgrowth of periodontal bacteria, suppressing immune factors, and initiation of other disease processes that lead to cell death.

In the early stages of periodontal disease, most treatment involves scaling and root planing-removing plaque and calculus around the tooth and smoothing the root surfaces. Antibiotics or antimicrobials may be used to supplement the effects of scaling and root planing. More advanced cases may require surgical treatment, which involves cutting the gums, and removing the hardened plaque build-up and recontouring the damaged bone. The procedure is also designed to smooth root surfaces and reposition the gum tissue so it will be easier to keep clean. Unfortunately, these methods are often painful, time-consuming and expensive and are often inadequate to prevent recurrence of periodontal disease.

Until now, the methods and devices for preventing periodontal disease have included various forms of tooth brushing with either manual or automated brushes, pressure cleaning with water or air, sometimes mixed with an abrasive substance, vibrative cleaning with ultrasonic instruments, or various forms of mouthwash containing antiseptic or antibacterial chemicals, all designed to prevent or remove plaque build up. Often, these techniques fail to reach deep enough into gaps, crevices and gum lines to effectively kill the bacteria and viruses known to cause periodontal disease.

It has been demonstrated that the application of heat at various time and temperature combinations reliably kills the P. acnes and Staphylococcus aureus bacteria, as well as the HSV1 virus. The necessary temperature range to kill bacteria is generally above 47° C., but below the burn or discomfort threshold for human skin. Depending on the area of skin and the area of surface contact, this upper threshold is in the range of 51° C. However, in the case of the skin inside the mouth, the upper threshold is higher as the human mouth can comfortably withstand much higher temperatures than other areas of the skin. Until now, no one has proposed a method or device to use heat as a means to combat the bacteria or viruses known to cause periodontal disease.

Other devices have used heat to address various issues in a patient's mouth. For example, U.S. Pat. No. 6,254,391 to Darnell entitled “Device for Heating the Teeth and Uses Thereof” (the “'391 patent”) describes a mouthpiece that may be heated as part of a teeth whitening system. The '391 patent suggests that the device may also be used to treat periodontal disease. However, the '391 patent teaches that the device should not contact or heat gingival tissue. As a result, the dental device in the '391 patent would not deliver heat to the gingival tissue of a patient which, because periodontal disease is a chronic bacterial infection that affects the gums, would render the device of the '391 patent ineffective in treating periodontal disease.

There is, therefore, a need for improved treatment and prevention of periodontal disease through methods or devices that are more effective and convenient and less painful, time-consuming and costly.

### BRIEF SUMMARY OF THE INVENTION

The concepts described herein relate to the use of a heat source that can be applied to the teeth and gums in order to accelerate the death of bacterial or viral systems as a means to treat or prevent periodontal disease.

In one embodiment, a device for treating or preventing periodontal disease is described. The device includes one or more thermally conductive surfaces designed to be placed in contact with the teeth and gums and a temperature sensor adjacent to the thermally conductive surface. The device further includes a heating element operable to heat the thermally conductive surface, and a controller electrically connected to the heating element and the temperature sensor, wherein the controller is operable to control the heating element in response to a signal from the temperature sensor and regulate the temperature of the thermally conductive surface to a treatment temperature.

In another embodiment a method of treating or preventing periodontal disease is described. The method includes heating the teeth and gums to a temperature and for a period of time capable of combating the bacteria or viruses known to contribute to periodontal disease.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows a perspective view of an embodiment of a treatment device according to the present invention;

FIG. 2 shows a perspective view of an embodiment of a mouthpiece component for use with a treatment device according to the present invention;

FIG. 3 shows a cross-sectional view of the mouthpiece component of FIG. 2 as applied to the teeth and gums;

FIG. 4 shows a perspective exploded view of the components of an embodiment of a heating element for use with a treatment device according to the present invention;

FIG. 5 shows an embodiment of a mouthpiece according to the present invention using the heating elements shown in FIG. 4;

FIG. 6 shows an embodiment of a segmented mouthpiece according to the present invention;

FIG. 7 shows an embodiment of a segmented mouthpiece according to the present invention in combination with the heating elements shown in FIG. 4;

FIG. 8 shows a simplified block diagram of the major electrical components treatment device of FIG. 1;

FIG. 9 is a diagram illustrating the control functionality of the firmware used in the present invention; and

FIG. 10 shows a state diagram illustrating the operation of a treatment device according to an embodiment of the present invention.

### DETAILED DESCRIPTION OF THE INVENTION

The present invention describes methods and devices for the treatment and prevention of periodontal disease through the application of a dose of thermal energy to the teeth and gums.

Devices and Methods of Treating Periodontal Disease

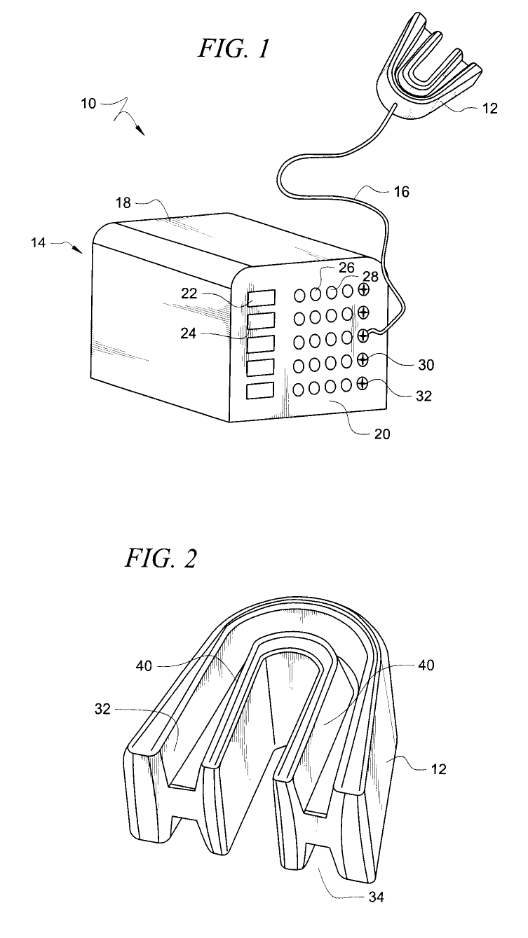

An embodiment of a device for treating or preventing periodontal disease is shown in FIG. 1. Treatment device 10 operates to transfer heat energy to the teeth and gums at a set temperature for a set period of time. The set temperature and set period of time can be varied to accommodate different disease conditions and patient tolerance levels. However, treatment device 10 preferably should be capable of heating a treatment surface to a temperature between about 46° C. and about 68° C. and sustaining one or more temperatures for between about 10 seconds and about 30 minutes. Although thermal damage generally occurs when human skin is heated to a temperature of approximately 66° C. or higher, an interface heated to this temperature or a higher temperature can nevertheless deliver an effective therapeutic amount of heat to the teeth and gums without resulting in thermal damage, depending on the amount of thermal energy delivered over a particular surface area and how readily the thermal energy is dissipated by the heated tissue.

Treatment device 10 comprises a mouthpiece 12 connected by wire leads 16 to a control unit 14. Housing 18 of control unit 14 comprises a protective cover to hold the internal electrical components of treatment device 10 and a user interface 20. By means of a user interface 20, the user may activate and monitor the device.

Housing 18 holds the internal electrical components and the power source, such as rechargeable batteries. While treatment device 10 is described as using rechargeable batteries as the preferred power source, any suitable power source may be used, including receiving power from an ordinary wall socket using a power cord. A speaker, not shown, is also housed in housing 18. The speaker can be used to provide audible information to the user such as the amount of time remaining in the treatment, an error condition, low battery charge, and any other audible information that might be useful or interesting to the user.

Control unit 14 includes a battery charge port 30 and a data port 32. Battery charge port 30 is used to plug in a charger to charge the internal batteries. Data port 32 allows treatment device 10 to communicate with another device, such as a computer or PDA, and allows the internal electrical components to receive new programs or new data to be used in treatment device 10. Although the embodiment shown in FIG. 1 contains battery charge port 30 and data port 32 on interface 20, battery charge port 30 and data port 32 may be found in another location of control unit 14.

Interface 20 includes power button 22 and treatment button 24. Power button 22 is used to turn treatment device 10 on and off. Treatment button 24 is used to initiate and/or cancel treatments. Treatment button 24 can include light emitting diodes (LEDs) 28 that indicate whether treatment device 10 is ready to begin a treatment. While the illustrated embodiment is shown using LEDs as a display, any display technology such as LCDs or other display may be used without departing from the concepts described herein. For example, LEDs 28 could include an amber light to indicate that the device is not ready to begin a treatment and a green light to indicate that treatment device 10 is ready to begin a treatment. Treatment device 10 may comprise additional LEDs not shown to provide additional visual information to the user, such as the charge remaining in the battery and any other information which may be useful or interesting to the user.

Referring now to FIG. 2, an embodiment of mouthpiece 12 from FIG. 1 is shown. The mouthpiece includes heated surfaces 40, which, when activated, deliver thermal energy sufficient to combat the bacteria and viruses known to contribute to periodontal disease. Heated surfaces 12 are oriented along the vertical surfaces in upper tray 32 and lower tray 34. Upper tray 32 and lower tray 34 are adapted to accept the upper and lower teeth, respectively, of a patient. Mouthpiece 12 may be a universal mouthpiece or may be a customizable mouthpiece which can be made to generally or specifically fit the mouth of a particular patient.

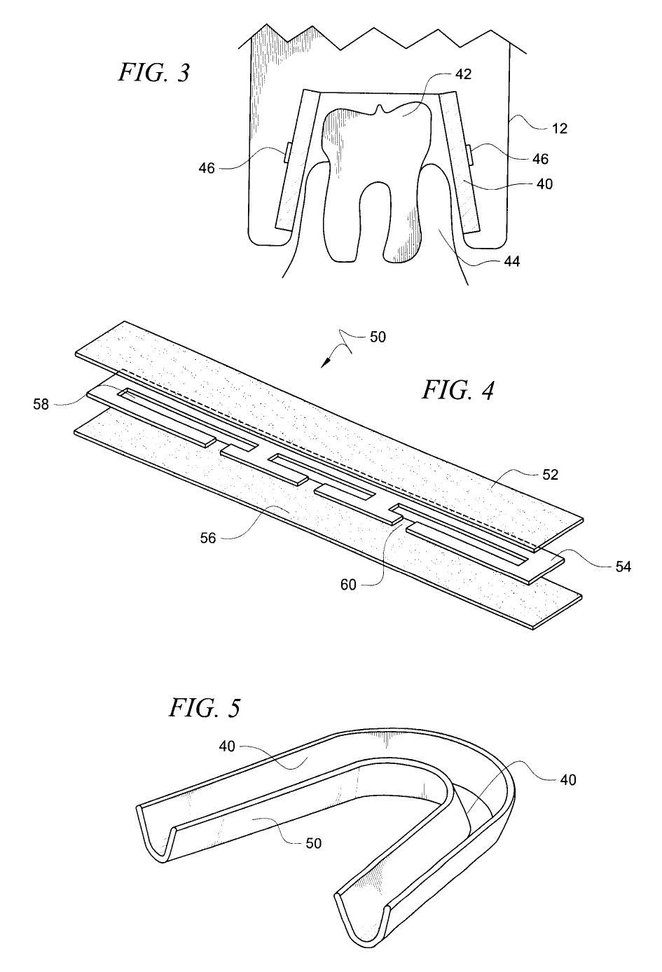

As shown more clearly in FIG. 3, the heated surfaces 40 in each of upper tray 32 and lower tray 34, are oriented so as to facilitate contact with teeth 42 and gums 44. In the preferred embodiment, heated surfaces 40 comprise a soft, flexible material designed to conform to the irregular shapes of teeth 42 and gums 44. Heated surfaces 40 are electrically connected to control unit 14 from FIG. 1 by electrical connection 16. Control unit 14 provides electrical current to heated surfaces 40 that produce heat through electrical resistance, which, in turn, is monitored by control unit 14. The temperature of heated surfaces 40 is monitored by temperature sensors 46, which may be thermistors or other electrical devices that develop and regulate heat. Control unit 14 is able to adjust the current provided to heated surfaces 40 so as to maintain heated surfaces 40 at or near a set temperature chosen for the treatment.

An alternate embodiment of mouthpiece 12 shown in FIG. 4 comprises laminations to create a formable strip or tape 50. Inner lamination 52 is preferably a soft, flexible material which could comprise further laminations not shown to contain a flexible thermal mass such as a gel material. Outer lamination 56 is preferably a formable material that retains its shape once formed, such as an aluminum foil, and may include further laminations not shown to facilitate comfort and ability to bond with inner lamination 52. Flexible circuit board 54 is contained between inner lamination 52 and outer lamination 56 whereby it is protected from moisture. The flexible thermal mass contained in inner lamination 52 holds inner lamination 52 onto circuit board 54. Flexible circuit board 54 contains electrical components used to perform the treatment mounted on its surface, such as resistive heating elements and temperature sensing elements. Notches 58 and slits 60 present in flexible circuit board 54 facilitate the folding and bending of formable strip or tape 50.

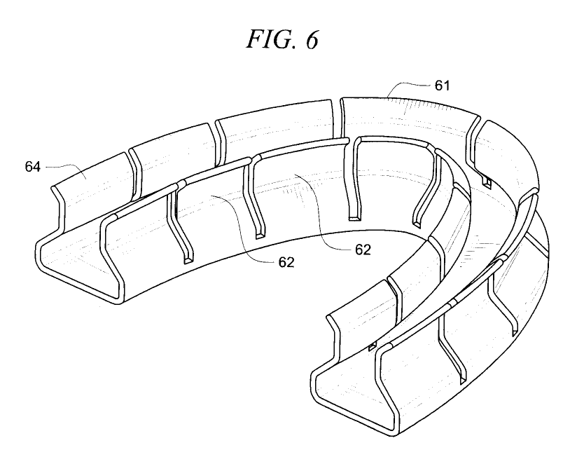

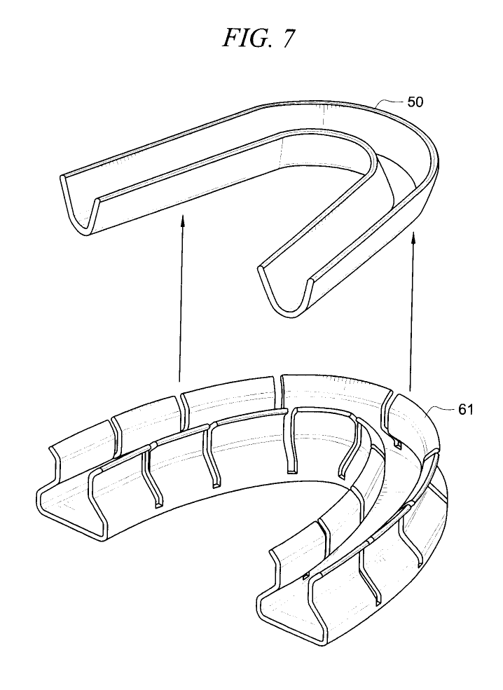

Referring now to FIG. 5, an embodiment of a single tray mouthpiece using the formable strip 50 is shown, formable strip or tape 50 is folded along its length and wrapped around the user's teeth and gums. One or more formable strips or tapes 50 are molded in such a way so as to form a mouthpiece for the user. The newly shaped mouthpiece contains heated surfaces 40 which comprise inner laminations 52 of the one or more formable strips or tapes 50 used to form the mouthpiece. As such, the newly formed mouthpiece shown in FIG. 5 contains a flexible circuit board 54 near each heated surface 40. As described with reference to FIG. 4, a flexible thermal mass connects flexible circuit board 54 to heated surface 40. The thermal mass serves to transfer the heat energy generated by the flexible circuit board 54 to the heated surface 40. Similarly, mouthpiece 12 as shown in FIGS. 2 and 3 may contain one or more heating elements in thermal communication with each heated surface 40.

Now referring to FIG. 6, an alternate embodiment of mouthpiece 12 shown in FIG. 1 is shown. Segmented zone mouthpiece 61 comprises one or more segmented zones 62 to allow universal fit around the varied topography of teeth. Segmented zone mouth 62 is made of a spring-like high memory plastic. The mouthpiece can be designed to include heated surfaces 64, such as along the gum line, which, when activated, deliver thermal energy sufficient to combat the bacteria and viruses known to contribute to periodontal disease. Where segmented zone mouthpiece 61 includes heated surfaces 64, those surfaces are electrically connected to control unit 14 from FIG. 1 by electrical connection 16. Control unit 14 provides electrical current to heated surfaces 64 that produce heat through electrical resistance, which, in turn, is monitored by control unit 14. The temperature of heated surfaces 64 is monitored by temperature sensors 46, which may be thermistors or other electrical devices that develop and regulate heat. Control unit 14 is able to adjust the current provided to heated surfaces 64 so as to maintain heated surfaces 64 at or near a set temperature chosen for the treatment.

Referring now to FIG. 7, segmented zone mouthpiece 61, instead of having integral heated surfaces, could be used in conjunction with formable strip 50, as described in FIG. 4. Formable strip 50 includes the heating element used to deliver thermal energy and segmented mouthpiece 61 holds strip 50 in place through spring tension of the segmented elements. As discussed with reference to FIG. 4, a mouthpiece or tray can be formed by folding formable strip 50 along its length and wrapped around the user's teeth and gums. The resulting mouthpiece contains heated surfaces 40 which comprise inner laminations 52 of the one or more formable strips or tapes 50 used to form the mouthpiece. Segmented mouthpiece 61 is then applied over the mouthpiece formed from formable strip 50. Segmented mouthpiece 61 provides pressure over formable strip 50 to help maintain good thermal contact of the heated surfaces with the teeth and gums.

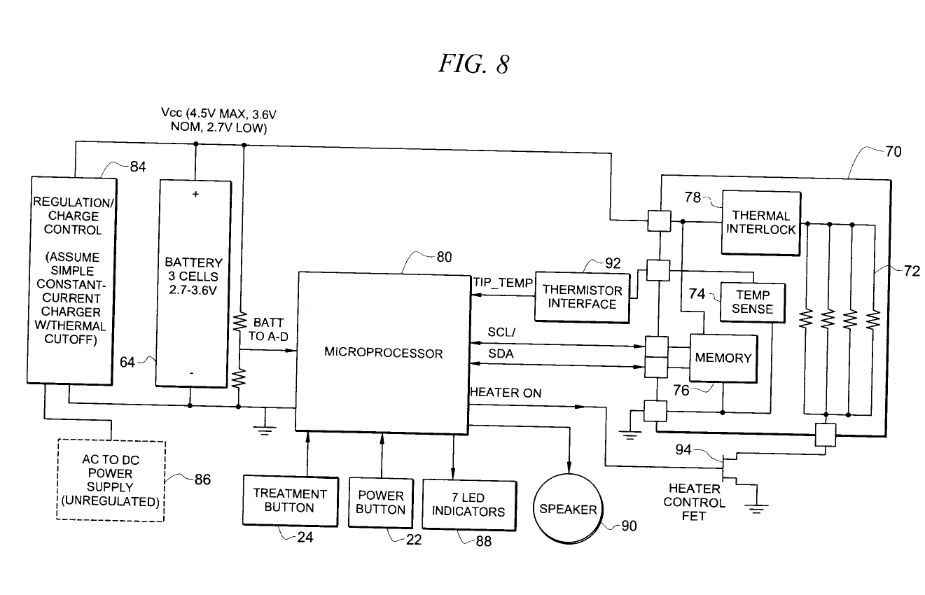

Referring now to FIG. 8, an electrical block diagram showing an embodiment of the electrical system of treatment device 10 is shown. Treatment device 10 includes mouthpiece components mounted on circuit board 70. Mouthpiece components on circuit board 70 include the electrical components used to perform the treatment mounted on its surface. Circuit board 70 contains resistors, thermistors and other control components to develop and regulate heat. Resistors 72 mounted onto circuit board 70 are used to convert electrical energy from power source to heat energy needed to increase the temperature of heated surface 40 of mouthpiece 12, shown in FIG. 2. Control of the temperature of heated surface 40 is done in response to signals from thermistor 74, mounted on circuit board 70. Thermistor 74 provides an electrical signal indicative of the temperature of heated surface 40 to microprocessor 80 in housing 18 of FIG. 1.

A memory element 76 may also mounted on circuit board 70. Memory element 76 can be any combination of processing and memory elements utilized to store and implement mouthpiece specific functions. Memory element 76 is used to store mouthpiece specific information. For example, memory element 76 of the illustrated embodiment may include calibration information for its associated mouthpiece. As the individual components used in particular mouthpieces may have their own variances from their marked values, each mouthpiece is calibrated during manufacturing to provide calibration information stored in memory element 76 and used to adjust the heating algorithm of treatment device 10 to account for the particular values of the components in the mouthpiece.

The memory element 76 can also store treatment variables such as treatment cycle duration, treatment temperature and treatment frequency, as well as other information that aids the treatment device in its operation. Such information can, for example, be information that identifies the type of mouthpiece and the intended treatment protocols, as well as algorithm information used during a treatment cycle.

An electrical diagram showing an embodiment of the electrical system of control unit 14 of treatment device 10 from FIG. 1 is also illustrated in FIG. 8. Control unit 14 includes microprocessor 80. Microprocessor 80 is programmed to respond to and control the various inputs and outputs of treatment device 10 from FIG. 1. Microprocessor 80 receives input from power button 22, and in response operates to power-up or power-down the treatment device accordingly. Microprocessor 80 also receives input from treatment button 24 and operates to start or stop treatment based on input from treatment button 24. LEDs 88 are turned on and off by microprocessor 80 to communicate visual information to the user, while speaker 90 is controlled by microprocessor 80 to communicate audible information to the user.

Microprocessor 80 is also in electrical communication with mouthpiece 12. Microprocessor 80 communicates with memory element 76 and exchanges information on mouthpiece cycles, calibration, treatment variations and other mouthpiece specific information. Microprocessor 80 also receives the signal from thermistor 74 through interface 92. Using the signal from thermistor 74, microprocessor 80 is operable to control the temperature of heated surfaces 40 of mouthpiece 12. Microprocessor 80 of the illustrated embodiment is connected to the gate of field effect transistor (“FET”) 94, and by varying the voltage at the gate of FET 94 is able to control the amount of current flowing through resistors 72. The heat produced by resistors 72 is proportional to the amount of current passing through them. Thermal interlock 78 provides a safety mechanism to ensure that the failure of thermistor 74 does not cause a dangerous operating temperature in the mouthpiece.

Microprocessor 80 is programmed with a control algorithm referred to as a proportional, integral, derivative or PID. A PID is a control algorithm which uses three modes of operation: the proportional action is used to dampen the system response, the integral corrects for droop, and the derivative prevents overshoot and undershoot. The PID algorithm implemented in microprocessor 80 operates to bring the heated surfaces 40 to the desired operating temperature as quickly as possible with minimal overshoot, and also operates to respond to changes in the temperature of heated surfaces 40 during the treatment cycle that are caused by the heat sink effect of the treatment area.

In addition to being connected to FET 94, resistors 72 are connected to battery 82 through thermal interlock 78, which can be a fuse having a maximum current rating chosen to prevent runaway overheating of resistors 72. Battery 82, which can be comprised of one or more individual cells, is charged by battery charger 84 when battery charger 84 is connected to external power supply 86. External power supply 86 can be any type of power supply, but is normally an AC to DC converter connected between battery charger 84 and an ordinary wall outlet. According to embodiments, the output voltage of battery 82 is directly related to the amount of charge left in battery 82, therefore, by monitoring the voltage across battery 82 microprocessor 80 can determine the amount of charge remaining in battery 82 and convey this information to the user using LEDs 88 or speaker 90. Other methods of determining battery voltages or charge for different battery technologies can also be used and are well within the scope of the present invention.

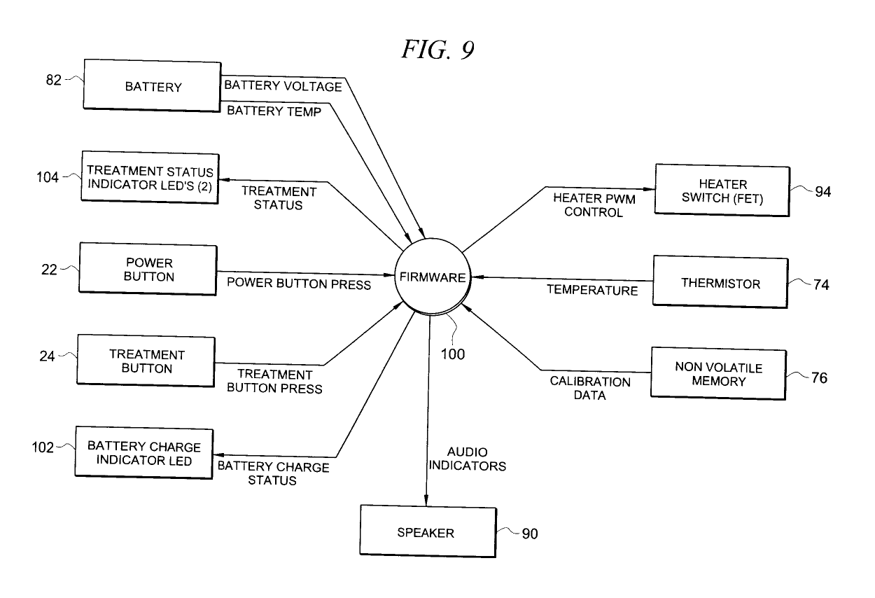

Referring now to FIG. 9, a diagram showing the various inputs to the firmware run by microprocessor 80 of FIG. 8 is described. Firmware 100 represents the programming loaded on microprocessor 80 from FIG. 8. As described with reference to FIG. 8, microprocessor 80 is operable to respond to and control the various aspects of treatment device 10 from FIG. 1. Firmware 100 is able to accept inputs from power button 22, treatment button 24, thermistor 74 and battery 82. Firmware 100 is also able to exchange information with memory element 76, such as calibration data. The microprocessor 80 and memory element 76 may exchange any other information that may increase the efficacy of treatment device 10.

In response to the thermistor input and information from memory element 76, firmware 100 controls FET 94 to regulate the temperature of the inner lamination according to the PID algorithm programmed into firmware 100. Firmware 100 also controls speaker 90 to provide audible feedback to the user and LEDs 102 and 104 which are subsets of LEDs 88 from FIG. 8, and provide indications of battery charge (LED 102) and treatment status (LEDs 104).

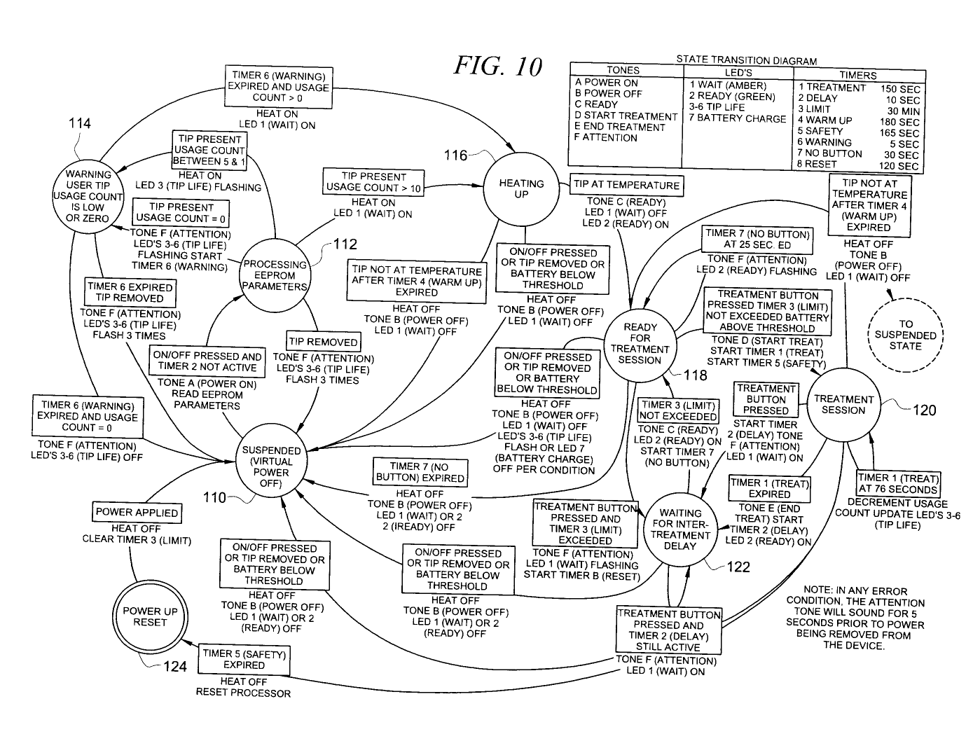

Referring now to FIG. 10, a state transition diagram showing various operating states of firmware 100 from FIG. 9 according to an embodiment is described. The state diagram begins a Suspended state 110 which is the power off state. During the power off mode the microprocessor is still receiving some power to allow it to monitor the power button. The Suspended state 110 is left when the power on button is pressed, and the state proceeds to the Processing Mouthpiece Memory state 112. In the Processing Mouthpiece Memory state 112 the microprocessor 80 and memory element 76 from FIG. 8 exchange mouthpiece specific treatment information. If the strip usage count is not low or zero, the state passes to Heating state 116. If the tip count is found to be low or zero the state progresses to the Warning state 114, which provides visual and or audible signals to the user to indicate that the mouthpiece count is low or zero. If the mouthpiece count is zero or the mouthpiece is removed, the state passes from the Warning state 114 to the Suspended state 110. If the mouthpiece count is low, but not zero the state passes from the Warning state 114 to the Heating state 116.

During the Heating state 116 the strip is heated using resistors 72 from FIG. 8. A predictive model is used to set a timer based on the amount of time that should be required for the mouthpiece to come to temperature. This timer acts as in indicator that the thermal mass is responding to the heating correctly. If the strip does not reach the predetermined operating temperature by the expiration of the timer, it is an indication of a potentially faulty component and the treatment device shuts down by transitioning to Suspended state 110. Other predictions of thermal mass behavior can also be used to detect potentially faulty components.

In addition to the expiration of the timer, the treatment device powers down by transitioning to the Suspended state if the power button is pressed, or the battery voltage falls below a threshold, and indication of the fault is provided to the user through visual and/or audible signals. If the mouthpiece successfully reaches the operating temperature within the designated time the state transitions to Ready state 118. A timer is started upon entering the Ready state 118. If the timer expires or the power button is pressed while in the Ready state 118, the state transitions to the Suspended state 110.

If the treatment button is pressed while in Ready state 118 the state transitions to Treatment state 120. Two timers, a treatment timer and a safety timer, are started upon entering the Treatment state 120. The safety timer is slightly longer than the treatment timer so that if there is a failure in the treatment timer the safety timer will expire and transition the state to the Power Reset state 124 before transitioning to the Suspended state 110. The state also transitions from Treatment state 120 to Suspended state 110 if the power button is pressed during a treatment cycle.

As a treatment cycle can be a relatively long period of time, the treatment device can also be programmed to provide visual and/or audible indications of the progress of the treatment timer. For example, speaker 90 of FIG. 8 can be used to provide intermittent tones during the treatment to let the user know that the treatment is continuing. The time between the tones could be spaced to provide an indication of the remaining time in the treatment cycle, such as by shortening the time between the tones as the cycle gets closer to the end. Many other methods of providing visual or audible feedback could be contemplated and are well within the scope of the present invention.

When the treatment timer expires, or if the treatment button is pressed, the state transitions from Treatment state 120 to Wait state 122 which forces an inter-treatment delay. If the power button is pressed or the mouthpiece removed during the Wait state, the state transitions to Suspended state 110. After the expiration of the inter-treatment delay the state transitions back to Ready state 118. In addition to the inter-treatment delay, the Wait state 122 can be used to force a temporal treatment limit. While the inter-treatment delay forces a relatively brief delay between treatment cycles, the temporal treatment limit acts to limit the number of treatments that can be performed in specified period. For example, if the treatment cycle is two and a half minutes and the inter-treatment delay is 10 seconds, a temporal treatment limit of 30 minutes could be used to limit the device to approximately 10 to 11 consecutive treatments before a forced interval is imposed.

In another embodiment of the treatment device 107 an antibacterial or antiseptic compound may be introduced at heated surfaces 40, adding to the killing effect provided by the thermal energy. In turn, the heat created by heated surfaces 40 will aid in the dispersing and absorbing of such compounds creating a synergistic effect.

In yet another embodiment of the treatment device 10, a whitening compound may be introduced at heated surfaces 40, allowing users to perform the dual functions of treating or preventing periodontal disease and tooth whitening at the same time. This will be particularly useful where whitening compounds are used that will benefit from heat as a reagent.

Preferred Set Temperature and Treatment Time

To determine the preferred set temperature and treatment time, two factors must be considered. First, the set temperature and treatment time must be sufficient to cause thermal damage to the virus or bacteria detrimentally affecting the gum surface. Second, the set temperature and treatment time must be below the threshold that would damage the skin being treated. The first factor is discussed with reference to Examples 1-3 below using exemplary infectious agents. Based on Examples 1-3 a set temperature of 121° F. (49.44° C.) for a period of 150 seconds proves to be effective for a variety of infectious agent and irritants. While a set temperature of 121° F. and a treatment time of 150 seconds are chosen for an embodiment of the present invention, other embodiments using combinations of set temperatures and treatment times which depart significantly from the described embodiment are well within the scope of the present invention.

To ensure that the described embodiment of a set time and temperature do not cause burn damage to the treatment area, modeling can be performed against previous research done into burn injuries. The modeling assumes that the skin surface in contact with the applicator immediately reaches the applicator temperature of 121° F. and remains at that temperature for the entire 150 seconds. First, the set temperature and treatment time are plotted against the Time-Surface Temperature Thresholds plot represented in FIG. 4, page 711 from Moritz and Henriques, “Studies of Thermal Energy,” American Journal of Pathology, 1947, Vol. 23, pp. 695-720, the disclosure of which is incorporated by reference. The plot of 49.44° C. at 150 seconds is just under the dashed curve representing “the first morphological evidence of thermal damage,” such as slight reddening. At the set temperature, the curve indicates that the first reversible damage occurs at 195 seconds. Thus, according to Moritz and Henriques, the set temperature and treatment time are safe, and at worse might produce slight reddening of the treatment area.

Based on the data of Moritz and Henriques cited above, Xu and Qian in an article entitled “Analysis of Thermal Injury Process Based on Enzyme Deactivation Mechanisms,” in Journal of Biomechanical Engineering, Transactions of the ASME, Vol. 117, pp. 462-465 (1995), the disclosure of which is incorporated by reference, developed an equation for a damage function, 6, based on enzyme deactivation concepts.

$$Ω = {\int }_{0}^{t} \frac{1 * {10}^{- 4} exp ( 100 z )}{1 + 8 * {10}^{4} exp ( - 195 z )} ⅆ t$$

where z=1-305.65/T ° K, and t is in seconds

In this model T=322.59° K and is constant, therefore,

Ω=4.947*10⁻³*Δt=0.742 for 150 seconds.

### EXAMPLE 1

Temperature dependent death curves for P. acnes.

While the bacteria P. acnes is not normally present in the mouth, nor the cause of periodontal disease, the reaction of P. acnes to heating can be considered illustrative of the expected reactions of those infection agents which are responsible for periodontal disease and other oral conditions treatable by the device described herein.

Materials and Methods: The bacterial strain P. acnes was purchased from The American Type Culture Collection ATCC (No. 11827, Lot 419571, Manassas, Va.). The cultures were stored in KWIK-STIK lyophilized preparations. The lyophilized cells (P. acnes) were rehydrated according to the manufacturers recommendations and initially grown on a streak plate to isolate individual colonies under anaerobic conditions. These plates were then incubated overnight at 37° C. in an anaerobic chamber. Individual colonies were then isolated and inoculated into TSB-growth media with medium agitation overnight. From these aliquots of 0.1 ml of TSB broth culture was added to the 0.9 ml of PBS sterile buffer. This mixture was then transferred to thin-walled Eppendorf 1.5 ml tubes and placed in a heating block at various times and temperatures. The cultures after specific incubation times were removed and 0.1 ml of the material was plated onto TSA plates. This mixture was then spread with a sterile hockey-stick and then allowed to incubate at 37° C. for 5 days in anaerobic conditions. The plates were then removed and colonies were counted and recorded. The results are demonstrated in FIG. 10. FIG. 10 demonstrates the rapid decline of P. acnes in response to various temperatures and duration of treatment. The baseline P. acnes colony count that had not been exposed to the heat source was 1050.

Results: A general trend of reduction of required time to kill the bacterial strain is seen at higher temperature incubations. Also of note is the temporal thermal threshold where the number of colonies drops off in a very steep fashion. By using the curves generated by such experiments the optimal thermal output and the timing for each temperature can be extrapolated for a localized heating device. The in vitro data shown demonstrates significant sensitivity of P. acnes bacterial cells to the effects of sustained low-level heat. Temperatures of 55° C. result in the death of substantially all of the bacteria after 3½ minutes. Temperatures of 58 and 59° C. result in the death of substantially all of the bacteria after 2 minutes. These curves demonstrate that P. acnes can be rendered largely non-viable by treatment under the conditions shown by the death curves.

### EXAMPLE 2

Again, though acne is a skin condition, the treatment of skin lesions using heat is considered to be illustrative of utility of heat treatment for periodontal disease and other oral conditions using the concepts described herein.

Treatment of acne lesions in human subjects. The inventors have performed preliminary studies on over 100 volunteers experiencing outbreaks of acne lesions. All subjects reported being satisfied with the results obtained. The results showed a clear response to treatment in approximately 90% of subjects treated. No subject reported any serious adverse effects due to treatment. Furthermore, we have discovered that a treated lesion heals more than 80% faster than untreated lesions.

The electrical device used in the present study had an interface of approximately 0.4 cm2. The interface of the device was heated to a constant temperature of approximately 48-50° C. prior to application of the device to the skin surface, and the temperature was maintained during the treatment period. Each of the subjects was given instructions on how to use the device and was monitored during the treatment. The treatment consisted of a 2 minute application of the device to the lesion site. The study called for the application of two treatment cycles to each patient, with the second treatment cycle being administered 12 hours after the first. In practice, however, the treatments were frequently only conducted once on each subject because twelve hours after the first treatment many of the lesions had healed to an extent that they did not require any further treatment.

Results of experiments performed on volunteer subjects are listed in Table 1. Members of the control group were not treated. Members of the treatment group were treated as described above, Both groups either examined or self-reported the results of treatment over the following 14 days. Only results from study participants who reported data for 14 days were included in the table. The data is reported in terms of the size of the lesion prior to treatment. A lesion size of 100% indicates that the lesion size was unchanged. Lesion size was approximated in increments of 10%. A lesion size of 0% indicates that the lesion had fully healed.

TABLE 1

| | | | | Day | Day | Day | Day | Day | Day | Day | Day | Day | Day | Day | Day | Day | Day |
|---|---|---|---|---|---|---|---|---|---|---|---|---|---|---|---|---|---|
| # | Name | Gender | Age | 1 | 2 | 3 | 4 | 5 | 6 | 7 | 8 | 9 | 10 | 11 | 12 | 13 | 14 |

Control Group

| | | | | | | | | | | | | | | | | | |
|---|---|---|---|---|---|---|---|---|---|---|---|---|---|---|---|---|---|
| 1 | LEF | F | 27 | 100% | 100% | 100% | 100% | 90% | 90% | 80% | 80% | 50% | 20% | 10% | 0% | 0% | 0% |
| 2 | AMC | F | 22 | 100% | 100% | 100% | 90% | 90% | 80% | 80% | 60% | 40% | 40% | 20% | 20% | 20% | 10% |
| 3 | AWC | F | 16 | 100% | 100% | 100% | 100% | 100% | 100% | 100% | 80% | 80% | 60% | 40% | 10% | 10% | 10% |
| 4 | KAC | F | 13 | 100% | 100% | 100% | 80% | 80% | 70% | 40% | 40% | 40% | 40% | 20% | 10% | 0% | 0% |
| 5 | ECP | F | 35 | 100% | 100% | 100% | 100% | 80% | 80% | 80% | 20% | 20% | 20% | 20% | 10% | 0% | 0% |
| 6 | KSL | F | 21 | 100% | 100% | 90% | 90% | 80% | 80% | 60% | 60% | 60% | 30% | 30% | 10% | 10% | 0% |
| 7 | NET | F | 18 | 100% | 100% | 100% | 80% | 80% | 80% | 60% | 60% | 60% | 30% | 30% | 30% | 10% | 10% |
| 8 | LHJ | F | 27 | 100% | 100% | 100% | 80% | 80% | 80% | 50% | 50% | 50% | 50% | 20% | 10% | 10% | 0% |
| 9 | TAA | F | 28 | 100% | 90% | 90% | 90% | 90% | 70% | 70% | 70% | 40% | 30% | 30% | 10% | 10% | 10% |
| | | | Total | 100% | 99% | 98% | 90% | 86% | 81% | 69% | 58% | 49% | 36% | 24% | 12% | 8% | 4% |
| 1 | ZAC | M | 15 | 100% | 100% | 100% | 100% | 80% | 80% | 60% | 60% | 60% | 40% | 30% | 30% | 10% | 0% |
| 2 | ZMP | M | 14 | 100% | 100% | 100% | 100% | 90% | 90% | 90% | 80% | 80% | 60% | 60% | 20% | 20% | 10% |
| 3 | MAP | M | 18 | 100% | 100% | 100% | 100% | 90% | 90% | 90% | 70% | 70% | 70% | 30% | 30% | 10% | 0% |
| 4 | CDC | M | 40 | 100% | 100% | 90% | 80% | 70% | 70% | 30% | 30% | 30% | 10% | 10% | 0% | 0% | 0% |
| 5 | CAC | M | 24 | 100% | 100% | 100% | 90% | 80% | 80% | 80% | 50% | 50% | 50% | 20% | 20% | 10% | 0% |
| 6 | RAA | M | 33 | 100% | 100% | 100% | 90% | 80% | 70% | 70% | 60% | 60% | 40% | 20% | 20% | 10% | 10% |
| | | | Total | 100% | 100% | 98% | 93% | 82% | 80% | 70% | 58% | 58% | 45% | 28% | 20% | 10% | 3% |
| | | | Totals | 100% | 99% | 98% | 91% | 84% | 81% | 69% | 58% | 53% | 39% | 26% | 15% | 9% | 4% |

Treatment Group

| | | | | | | | | | | | | | | | | | |
|---|---|---|---|---|---|---|---|---|---|---|---|---|---|---|---|---|---|
| 1 | AAS | F | 34 | 100% | 30% | 20% | 10% | 0% | 0% | 0% | 0% | 0% | 0% | 0% | 0% | 0% | 0% |
| 2 | ACC | F | 36 | 100% | 20% | 0% | 0% | 0% | 0% | 0% | 0% | 0% | 0% | 0% | 0% | 0% | 0% |
| 3 | AWC | F | 40 | 100% | 70% | 30% | 10% | 0% | 0% | 0% | 0% | 0% | 0% | 0% | 0% | 0% | 0% |
| 4 | BAB | F | 27 | 100% | 10% | 0% | 0% | 0% | 0% | 0% | 0% | 0% | 0% | 0% | 0% | 0% | 0% |
| 5 | CAB | F | 29 | 100% | 0% | 0% | 0% | 0% | 0% | 0% | 0% | 0% | 0% | 0% | 0% | 0% | 0% |
| 6 | CHH | F | 30 | 100% | 60% | 60% | 40% | 10% | 0% | 0% | 0% | 0% | 0% | 0% | 0% | 0% | 0% |
| 7 | DSF | F | 33 | 100% | 0% | 0% | 0% | 0% | 0% | 0% | 0% | 0% | 0% | 0% | 0% | 0% | 0% |
| 8 | GDL | F | 34 | 100% | 40% | 10% | 0% | 0% | 0% | 0% | 0% | 0% | 0% | 0% | 0% | 0% | 0% |
| 9 | HCD | F | 14 | 100% | 50% | 20% | 0% | 0% | 0% | 0% | 0% | 0% | 0% | 0% | 0% | 0% | 0% |
| 10 | HLL | F | 36 | 100% | 0% | 0% | 0% | 0% | 0% | 0% | 0% | 0% | 0% | 0% | 0% | 0% | 0% |
| 11 | JLP | F | 19 | 100% | 20% | 0% | 0% | 0% | 0% | 0% | 0% | 0% | 0% | 0% | 0% | 0% | 0% |
| 12 | JSH | F | 28 | 100% | 20% | 20% | 0% | 0% | 0% | 0% | 0% | 0% | 0% | 0% | 0% | 0% | 0% |
| 13 | JUL | F | 31 | 100% | 70% | 50% | 30% | 10% | 0% | 0% | 0% | 0% | 0% | 0% | 0% | 0% | 0% |
| 14 | KAC | F | 13 | 100% | 50% | 30% | 10% | 0% | 0% | 0% | 0% | 0% | 0% | 0% | 0% | 0% | 0% |
| 15 | KDJ | F | 20 | 100% | 20% | 0% | 0% | 0% | 0% | 0% | 0% | 0% | 0% | 0% | 0% | 0% | 0% |
| 16 | KEF | F | 26 | 100% | 10% | 0% | 0% | 0% | 0% | 0% | 0% | 0% | 0% | 0% | 0% | 0% | 0% |
| 17 | KFC | F | 17 | 100% | 0% | 0% | 0% | 0% | 0% | 0% | 0% | 0% | 0% | 0% | 0% | 0% | 0% |
| 18 | KST | F | 33 | 100% | 80% | 80% | 60% | 30% | 10% | 0% | 0% | 0% | 0% | 0% | 0% | 0% | 0% |
| 19 | LEF | F | 21 | 100% | 30% | 10% | 10% | 0% | 0% | 0% | 0% | 0% | 0% | 0% | 0% | 0% | 0% |
| 20 | LKD | F | 34 | 100% | 50% | 50% | 50% | 30% | 30% | 20% | 10% | 10% | 0% | 0% | 0% | 0% | 0% |
| 21 | LKJ | F | 15 | 100% | 70% | 40% | 20% | 10% | 0% | 0% | 0% | 0% | 0% | 0% | 0% | 0% | 0% |
| 22 | MDD | F | 35 | 100% | 20% | 0% | 0% | 0% | 0% | 0% | 0% | 0% | 0% | 0% | 0% | 0% | 0% |
| 23 | MDF | F | 19 | 100% | 50% | 10% | 0% | 0% | 0% | 0% | 0% | 0% | 0% | 0% | 0% | 0% | 0% |
| 24 | MEA | F | 38 | 100% | 70% | 30% | 20% | 20% | 10% | 0% | 0% | 0% | 0% | 0% | 0% | 0% | 0% |
| 25 | MLJ | F | 29 | 100% | 60% | 30% | 10% | 0% | 0% | 0% | 0% | 0% | 0% | 0% | 0% | 0% | 0% |
| 26 | NJM | F | 37 | 100% | 50% | 40% | 10% | 0% | 0% | 0% | 0% | 0% | 0% | 0% | 0% | 0% | 0% |
| 27 | RTY | F | 23 | 100% | 10% | 0% | 0% | 0% | 0% | 0% | 0% | 0% | 0% | 0% | 0% | 0% | 0% |
| 28 | SAH | F | 18 | 100% | 40% | 10% | 0% | 0% | 0% | 0% | 0% | 0% | 0% | 0% | 0% | 0% | 0% |
| 29 | SAL | F | 14 | 100% | 50% | 10% | 0% | 0% | 0% | 0% | 0% | 0% | 0% | 0% | 0% | 0% | 0% |
| 30 | SBH | F | 18 | 100% | 20% | 20% | 10% | 0% | 0% | 0% | 0% | 0% | 0% | 0% | 0% | 0% | 0% |
| 31 | SFH | F | 35 | 100% | 0% | 0% | 0% | 0% | 0% | 0% | 0% | 0% | 0% | 0% | 0% | 0% | 0% |
| 32 | SLB | F | 31 | 100% | 60% | 30% | 30% | 10% | 100% | 0% | 0% | 0% | 0% | 0% | 0% | 0% | 0% |
| 33 | TCA | F | 16 | 100% | 0% | 0% | 0% | 0% | 0% | 0% | 0% | 0% | 0% | 0% | 0% | 0% | 0% |
| 34 | TDB | F | 25 | 100% | 20% | 0% | 0% | 0% | 0% | 0% | 0% | 0% | 0% | 0% | 0% | 0% | 0% |
| 35 | TEM | F | 38 | 100% | 60% | 30% | 30% | 10% | 10% | 10% | 0% | 0% | 0% | 0% | 0% | 0% | 0% |
| 36 | TLS | F | 13 | 100% | 80% | 40% | 20% | 10% | 10% | 10% | 0% | 0% | 0% | 0% | 0% | 0% | 0% |
| 37 | TSJ | F | 36 | 100% | 50% | 30% | 10% | 10% | 0% | 0% | 0% | 0% | 0% | 0% | 0% | 0% | 0% |
| 38 | VYM | F | 21 | 100% | 80% | 80% | 80% | 50% | 30% | 10% | 10% | 10% | 0% | 0% | 0% | 0% | 0% |
| | | | Total | 100% | 37% | 21% | 12% | 5% | 5% | 1% | 1% | 1% | 0% | 0% | 0% | 0% | 0% |
| 1 | CAC | M | 40 | 100% | 20% | 10% | 0% | 0% | 0% | 0% | 0% | 0% | 0% | 0% | 0% | 0% | 0% |
| 2 | CDM | M | 39 | 100% | 60% | 40% | 10% | 10% | 0% | 0% | 0% | 0% | 0% | 0% | 0% | 0% | 0% |
| 3 | DAD | M | 16 | 100% | 20% | 10% | 0% | 0% | 0% | 0% | 0% | 0% | 0% | 0% | 0% | 0% | 0% |
| 4 | DDL | M | 21 | 100% | 0% | 0% | 0% | 0% | 0% | 0% | 0% | 0% | 0% | 0% | 0% | 0% | 0% |
| 5 | DFB | M | 35 | 100% | 80% | 80% | 40% | 20% | 10% | 10% | 10% | 10% | 0% | 0% | 0% | 0% | 0% |
| 6 | EHE | M | 14 | 100% | 20% | 0% | 0% | 0% | 0% | 0% | 0% | 0% | 0% | 0% | 0% | 0% | 0% |
| 7 | HAF | M | 33 | 100% | 60% | 60% | 20% | 20% | 10% | 10% | 0% | 0% | 0% | 0% | 0% | 0% | 0% |
| 8 | JEY | M | 15 | 100% | 20% | 20% | 10% | 0% | 0% | 0% | 0% | 0% | 0% | 0% | 0% | 0% | 0% |
| 9 | JKG | M | 18 | 100% | 40% | 10% | 10% | 0% | 0% | 0% | 0% | 0% | 0% | 0% | 0% | 0% | 0% |
| 10 | KEG | M | 36 | 100% | 0% | 0% | 0% | 0% | 0% | 0% | 0% | 0% | 0% | 0% | 0% | 0% | 0% |
| 11 | KSP | M | 31 | 100% | 30% | 30% | 10% | 10% | 0% | 0% | 0% | 0% | 0% | 0% | 0% | 0% | 0% |
| 12 | MJP | M | 34 | 100% | 20% | 20% | 10% | 0% | 0% | 0% | 0% | 0% | 0% | 0% | 0% | 0% | 0% |
| 13 | OAP | M | 20 | 100% | 90% | 40% | 20% | 10% | 0% | 0% | 0% | 0% | 0% | 0% | 0% | 0% | 0% |
| 14 | PLT | M | 38 | 100% | 70% | 50% | 30% | 10% | 10% | 0% | 0% | 0% | 0% | 0% | 0% | 0% | 0% |
| 15 | RAA | M | 21 | 100% | 20% | 20% | 0% | 0% | 0% | 0% | 0% | 0% | 0% | 0% | 0% | 0% | 0% |
| 16 | RDC | M | 30 | 100% | 30% | 10% | 10% | 0% | 0% | 0% | 0% | 0% | 0% | 0% | 0% | 0% | 0% |
| 17 | RCJ | M | 25 | 100% | 60% | 20% | 20% | 20% | 10% | 0% | 0% | 0% | 0% | 0% | 0% | 0% | 0% |
| 18 | TFL | M | 16 | 100% | 0% | 0% | 0% | 0% | 0% | 0% | 0% | 0% | 0% | 0% | 0% | 0% | 0% |
| 19 | SHT | M | 28 | 100% | 20% | 10% | 0% | 0% | 0% | 0% | 0% | 0% | 0% | 0% | 0% | 0% | 0% |
| 20 | DKP | M | 36 | 100% | 50% | 10% | 10% | 0% | 0% | 0% | 0% | 0% | 0% | 0% | 0% | 0% | 0% |
| 21 | WRT | M | 28 | 100% | 30% | 10% | 0% | 0% | 0% | 0% | 0% | 0% | 0% | 0% | 0% | 0% | 0% |
| 22 | WJK | M | 32 | 100% | 80% | 80% | 60% | 40% | 40% | 20% | 20% | 10% | 10% | 0% | 0% | 0% | 0% |
| 23 | PLL | M | 24 | 100% | 20% | 0% | 0% | 0% | 0% | 0% | 0% | 0% | 0% | 0% | 0% | 0% | 0% |
| 24 | MWT | M | 31 | 100% | 0% | 0% | 0% | 0% | 0% | 0% | 0% | 0% | 0% | 0% | 0% | 0% | 0% |
| 25 | TTM | M | 26 | 100% | 10% | 10% | 0% | 0% | 0% | 0% | 0% | 0% | 0% | 0% | 0% | 0% | 0% |
| 26 | BTL | M | 37 | 100% | 60% | 30% | 10% | 10% | 0% | 0% | 0% | 0% | 0% | 0% | 0% | 0% | 0% |
| 27 | DWD | M | 22 | 100% | 70% | 20% | 20% | 10% | 0% | 0% | 0% | 0% | 0% | 0% | 0% | 0% | 0% |
| | | | Total | 100% | 36% | 22% | 11% | 6% | 3% | 1% | 1% | 1% | 0% | 0% | 0% | 0% | 0% |
| | | | Totals | 100% | 37% | 21% | 11% | 6% | 4% | 1% | 1% | 1% | 0% | 0% | 0% | 0% | 0% |

### EXAMPLE 3

The inventors have tested prototype devices on multiple oral herpes lesions of human volunteers, and the results have shown a complete termination of the herpetic lesion after two applications of the device at 2½ minutes per treatment, 12 hours apart, as described in Example 2. The volunteers reported a marked decrease in healing time after treatment versus the usual healing cycle for lesions of this type.

All of the compositions and methods disclosed and claimed herein can be made and executed without undue experimentation in light of the present disclosure. While the compositions and methods of this invention have been described in terms of preferred embodiments, it will be apparent to those of skill in the art that variations can be applied to the devices or methods and in the steps or in the sequence of steps of the methods described herein without departing from the concept, spirit and scope of the invention. More specifically, it will be apparent that certain mechanical elements related to those described above can be substituted for the mechanical elements described herein to achieve the same or similar results. All such similar substitutes and modifications apparent to those skilled in the art are deemed to be within the spirit, scope and concept of the invention as defined by the appended claim.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A device for treating or preventing periodontal disease comprising:
at least one segmented mouthpiece having one or more thermally conductive surfaces designed to be placed in contact with the teeth and gums;
a temperature sensor adjacent to the thermally conductive surface;
a heating element operable to heat the thermally conductive surface; and
a controller electrically connected to the heating element and the temperature sensor, wherein the controller is operable to control the heating element in response to a signal from the temperature sensor and regulate the temperature of the thermally conductive surface to a treatment temperature.

2. The device in claim 1 wherein the treatment temperature is within a temperature range capable of combating the bacteria or viruses known to contribute to periodontal disease.

3. The device in claim 1 wherein the treatment temperature is a temperature between 46° C. and 65° C.

4. The device in claim 1 wherein the controller comprises a microprocessor.

5. The device in claim 1 wherein the controller comprises a timer.

6. The device in claim 5 wherein the timer operates between 10 seconds and 30 minutes.

7. The device in claim 1 wherein the one or more thermally conductive surfaces are integrated in a mouthpiece.

8. The device in claim 7 wherein the segmented mouthpiece comprises one or more circuit boards, wherein the circuit board comprises the temperature sensor and the heating element.

9. The device in claim 8 wherein the temperature sensor comprises one or more thermistors and the heating element comprises one or more resistors.

10. The device in claim 9 wherein the circuit board further comprises a memory element and a thermal interlock.

11. The device in claim 1 wherein the one or more thermally conductive surfaces are integrated in one or more formable strips or tapes held in place by the segmented mouthpiece.

12. The device in claim 11 wherein the formable strip or tape comprises one or more flexible circuit boards, wherein the flexible circuit board comprises the temperature sensor and the heating element.

13. The device in claim 12 wherein the temperature sensor comprises one or more thermistors and the heating element comprises one or more resistors.

14. The device in claim 13 wherein the circuit board her comprises a memory element and a thermal interlock.

15. The device in claim 1 wherein the controller includes a feed back loop for temperature control.

16. The device in claim 1 wherein the controller comprises a separate housing and is connected to the contact surfaces by wire leads.

17. The device in claim 16 wherein the separate housing comprises a user interface.

18. The device in claim 1 wherein the controller comprises a separate housing and is linked to the contact surfaces by radio frequency.

19. The device in claim 18 wherein the separate housing comprises a user interface.

20. A device for treating periodontal disease in a patient's teeth and gums, the device comprising:
a segmented mouthpiece having at least one tray shaped to fit over the patient's teeth and gums, the segmented mouthpiece including one or more heating surfaces adjacent to the patient's gumline; and
a control unit electrically connected to the segmented mouthpiece, the control unit operable to control the one or more heating surfaces in the segmented mouthpiece to maintain the one or more heating surfaces at a preset treatment temperature.

21. The device of claim 20 further comprising a temperature sensor adjacent to the heating surfaces, the control unit operable to use the output of the temperature sensor to control the heating surfaces.

22. A device for treating periodontal disease in a patient's teeth and gums, the device comprising:
a segmented mouthpiece in combination with at least one tray shaped to fit over the patient's teeth and gums, the tray including one or more heating surfaces adjacent to the patient's gumline; and
a control unit electrically connected to the segmented mouthpiece, the control unit operable to control the one or more heating surfaces in the segmented mouthpiece to maintain the one or more heating surfaces at a preset treatment temperature.

23. The device of claim 22 wherein the at least one tray is formed from a flexible strip.

24. The device of claim 23 wherein the flexible strip includes a deformable thermally conductive material adjacent to the heating surfaces, the deformable material able to deform when placed in contact with the patent's teeth and gums to provide increased surface contact with the segmented mouthpiece.
